(19) United States
(12) Patent Application Publication
(10) Pub. No.: US 2016/0226061 A1
(43) Pub. Date: Aug. 4, 2016

(54) BATTERIES USING VERTICALLY FREE-STANDING GRAPHENE, CARBON NANOSHEETS, AND/OR THREE DIMENSIONAL CARBON NANOSTRUCTURES AS ELECTRODES

(71) Applicant: VERTICAL CARBON TECHNOLOGIES, INC., Yorktown, VA (US)

(72) Inventors: Wei ZHENG, Williamsburg, VA (US); Xin ZHAO, Yorktown, VA (US)

(21) Appl. No.: 14/613,617

(22) Filed: Feb. 4, 2015

(51) Int. Cl. H01M 4/36; H01M 4/583

(52) U.S. Cl. CPC H01M 4/366; H01M 4/583; H01M 2004/028

(57) ABSTRACT

A graphene-based battery includes an anode, a cathode and an electrolyte. The electrodes of anode and cathode include vertically free-standing graphene, carbon nanosheets, and/or three-dimensional (3D) carbon nanostructures in various configurations. For example, the carbon nanosheets are disposed orthogonally to a surface, and include a single layer or multiple layers of graphene. The vertically free-standing carbon nanosheets are coated with an active material as the cathode. A liquid, gel or solid-state electrolyte is either pseudo-morphologically coated on the surface of free-standing carbon nanosheets, or fully impregnates the space between the free-standing carbon nanosheets. Essentially, the vertically free-standing carbon nanosheets function as space-organizers at nanoscale. By partitioning the space between the anode and the cathode, the vertically free-standing carbon nanosheets can greatly enlarge the surface area of the loaded active material, and provide utterly high electrical conductivity, by virtue of physical properties of graphene.

### FIELD OF THE DISCLOSURE

The technology disclosed herein relates generally to a field of graphene-based batteries. More particularly, the technology disclosed herein relates to fabrication of three-dimensional nano-structure in electrodes of batteries.

### BACKGROUND AND SUMMARY

A battery is a device consisting of electrochemical cells that convert stored electrochemical energy into electrical energy. Each electrochemical cell contains a cathode, an anode, and an electrolyte. The cathode and the anode are the electrodes of a battery. The electrolyte allows transport of charge-carriers (ions) between the anode and the cathode, but blocks transport of electrons. The cathode and the anode are connected with an external electrical circuit, and they direct electric current circulating out of the battery to drive an external device.

Redox reactions and/or ions intercalation power a battery. The anions and the cations migrate between the cathode and anode. The electrolyte physically separates but electrically connects the electrodes. Various materials can be used as electrolytes in batteries. A differential voltage across electrodes of a cell, also known as an electrical driving force, is measured in volts, and it is determined by the difference between reduction potentials of the electrodes.

Energy storage capacity and deliverable power are critical operational characteristics of a battery. A battery's energy storage capacity is proportional to the amount of electric charge being delivered at the differential voltage. Energy storage capacity is determined by both specific capacity of a loaded active material and total mass of an electrode active material, and it is usually measured by unit mAh or Wh. On the other hand, deliverable power of a battery is determined by both working voltage and rendered current of the battery, and it is measured by Watts. The rendered current is limited by ionic and electrical conductivity of the electrodes. For rechargeable (a.k.a. Secondary) batteries, conductivity is critical to reaching a high recharging speed. Higher conductivity minimizes the internal resistance of a battery and reduces energy loss from the battery, which wastefully dissipates in the form of heat. Therefore, higher conductivity enhances the efficiency of a battery.

Battery performance is limited by various factors, for example:

1) The total volume of an electrode active material and the total energy storage capacity of a battery are restricted by the electrode active material, as the maximum thickness of the loaded electrode active material is restricted by mechanical strength of the electrode active material and accessibility of electric charges.

2) Cathode active materials limit output power and charging/discharging speed of rechargeable batteries, as they normally are binary or ternary metal-oxides, which have poor conductivity. The thicker an oxide cathode active material is, the poorer its conductivity is. Therefore, the selection of a cathode active material involves a trade-off between energy capacity and output power of a battery.

3) From the microscopic perspective, the interface between a cathode active material (e.g., in the form of ceramic oxide) and a current collector (e.g., a metal layer) increases electrical resistance of the electrodes, and hence impairs performance of a battery.

4) The cathode active material/current collector interface and cathode active material/electrolyte interface have limited specific area, which constrains conductivity of electrons, and thus limiting power of a battery, especially in the case of solid-state thin film batteries.

In order to improve battery performance, advanced materials need to be used as active materials. Thin films are materials with thickness in a range of microns or less. A thin film battery comprises an anode, an electrolyte (also a separator), and a cathode in thin film format, which could be a few nanometers or micrometers thick. Thin film batteries (TFBs) allow for some special applications like smart cards or implantable medical devices by virtue of their reduced weights and dimensions. TFBs can be formed into any shape and can be stacked, thus further reducing the space needed.

Solid-state thin film batteries (SSTFBs) are thin film batteries that have both solid electrodes and solid electrolytes. SSTFBs are normally made by thin film evaporation or sputtering techniques. SSTFBs have certain advantages over batteries using wet electrolytes such as: 1) easier to miniaturize; 2) no danger of explosion or no flammable hazard raised by wet electrolyte leakage; 3) very long shelf time; 4) longer cycling life for rechargeable applications; 5) larger acceptable temperature range for operation; 6) larger specific energy (Wh/kg). A major drawback of contemporary SSTFBs is their low specific power (kW/kg), due to defects along a solid electrolyte interface (a.k.a SEI).

As one kind of thin film material, a carbon nanosheet is a novel carbon nanomaterial with a graphene and graphitic structure developed by Dr. J. J. Wang et al. at the College of William and Mary. As used herein, a “carbon nanosheet” refers to a carbon nanomaterial with a thickness of two nanometers or less. A carbon nanosheet is a two-dimensional graphitic sheet made up of a single to several layers of graphene. Thus, thickness of a carbon nanosheet can vary from a single graphene layer to multiple layers, such as one to seven layers of graphene. For example, a carbon nanosheet may comprise one to three graphene layers and has thickness of one nanometer or less. Edges of a carbon nanosheet usually terminate by a single layer of graphene. The specific surface area of a carbon nanosheet is between 1000 m²/g to 2600 m²/g. The height of a carbon nanosheet varies from 100 nm to 8 μm, depending on fabrication conditions. The width of a carbon nanosheet also varies from hundreds of nanometers to a few microns.

A plurality of carbon nanosheets, each of which comprises at least one layer of graphene, are disposed orthogonally to a coated surface of a substrate. Essentially, the plurality of vertically free-standing carbon nanosheets are functioning as space-organizers at nanoscale. By partitioning the space above the surface of the substrate, these vertically free-standing carbon nanosheets can greatly enlarge the surface area of the substrate.

Hereby the term “free standing” or the term “vertically free-standing” refers to attaching carbon nanostructures to a surface orthogonally, or at various angles from 0 to 180 degree with respect to the surface. Furthermore, carbon nanostructures stretch out not only in a straight way, but also can have a crumpling, tilting, folding, sloping, or “origami”-like structure.

By virtue of their graphene and graphitic structure, carbon nanosheets have very high electrical conductivity. Graphene is known as one of the strongest materials, and it has a breaking strength over 100 times greater than that of a hypothetical steel film of the same thickness. Morphology of carbon nanosheets can remain stable at temperatures up to 1000° C. A carbon nanosheet has a large specific surface area because of its sub-nanometer thickness. Referring to FIG. 4, it shows an exemplary carbon nanosheet consisting of one layer of graphene. With only 1 to 7 layers of graphene, the carbon nanosheet is about 1 nm thick. Its height and length is about 1 micrometer respectively. The structure and fabrication method of carbon nanosheets have been published in several peer-reviewed journals such as: Wang, J. J. et al., “Free-standing Subnanometer Graphite Sheets”, Applied Physics Letters 85, 1265-1267 (2004); Wang, J. et al., “Synthesis of Carbon Nanosheets by Inductively Coupled Radio-frequency Plasma Enhanced Chemical Vapor Deposition”, Carbon 42, 2867-72 (2004), Wang, J. et al., “Synthesis and Field-emission Testing of Carbon Nan flake Edge Emitters”, Journal of Vacuum Science & Technology B 22, 1269-72 (2004); French, B. Wang, J. J., Zhu, M. Y. & Holloway, B. C., “Structural Characterization of Carbon Nanosheets via X-ray Scattering”, Journal of Applied Physics 97, 114317-1-8 (2005); Zhu, M. Y. et al., “A mechanism for carbon nanosheet formation”, Carbon, 2007.06.017; Zhao, X. et al., “Thermal Desorption of Hydrogen from Carbon Nanosheets”, Journal of Chemical Physics 124, 194704 (2006), as well as described by Zhao, X. in U.S. Patent “Supercapacitor using carbon nanosheets as electrode” (U.S. Pat. No. 7,852,612 B2); and Wang, J. et al., in U.S. Patent “Carbon nanostructures and methods of making and using the same” (U.S. Pat. No. 8,153,240 B2), which are incorporated herein by reference in their entirety.

Certain exemplary embodiments relate to a thin film battery comprising a cathode, an anode, and an electrolyte located between the cathode and the anode. The cathode includes a cathode active material and a plurality of carbon nanosheets, which comprises a single-layer or multiple layers of graphene. The plurality of carbon nanosheets are vertically free-standing with respect to a surface to which they are attached, such that the plurality of carbon nanosheets are embedded or immersed into the cathode active material. Moreover, the cathode includes a current collector, which is partially covered by the plurality of carbon nanosheets.

In one exemplary embodiment, the cathode active material is conformally coated on top of the current collector and the plurality of carbon nanosheets, and the electrolyte is conformally coated on top of the cathode active material. The anode comprises an anode active material and a current collector, and the anode active material fully impregnates the porous space between the plurality of carbon nanosheets, forming a planar topography on its top surface interfacing with the current collector of the anode.

In another exemplary embodiment, the cathode active material fully impregnates and fills up the nanoporous space between the plurality of carbon nanosheets and on top of the current collector, forming a planar topography on its top surface to contact with the electrolyte. The electrolyte is coated on top of the cathode and follows the contour of the cathode to form a planar structure.

Other aspects, features, and advantages of this invention will become apparent from the following detailed description when taken in conjunction with the accompanying drawings, which are a part of this disclosure and which illustrate, by way of example, principals of this invention.

### BRIEF DESCRIPTION OF THE DRAWINGS

The accompanying drawings facilitate an understanding of the various embodiments of this invention. In such drawings:

FIG. 1 is a schematic diagram of a battery in accordance with a first exemplary embodiment in a cross-sectional view.

FIG. 2 is a schematic diagram of a battery in accordance with a second exemplary embodiment in a cross-sectional view.

FIG. 3 is a schematic diagram of an exemplary vertically free-standing carbon nanosheet in a cross-sectional view.

FIG. 4 is an illustration diagram of an exemplary carbon nanosheet consisting of a single layer of graphene.

### DETAILED DESCRIPTION OF EXEMPLARY EMBODIMENTS

Certain exemplary embodiments relate to techniques for graphene-based batteries. More particularly, certain exemplary embodiments relate to techniques for fabrication of three-dimensional nano-structural electrodes of batteries.

In accordance with the techniques of certain exemplary embodiments, a battery using vertically free-standing graphene, carbon nanosheets, and/or 3D carbon nanostructures as components of cathode and a method of making the battery are described herein. In the following description, for purpose of explanation, numerous specific details are set forth to provide a thorough understanding of the exemplary embodiments. It will be evident, however, to person skilled in the art that the exemplary embodiments may be practiced without these specific details.

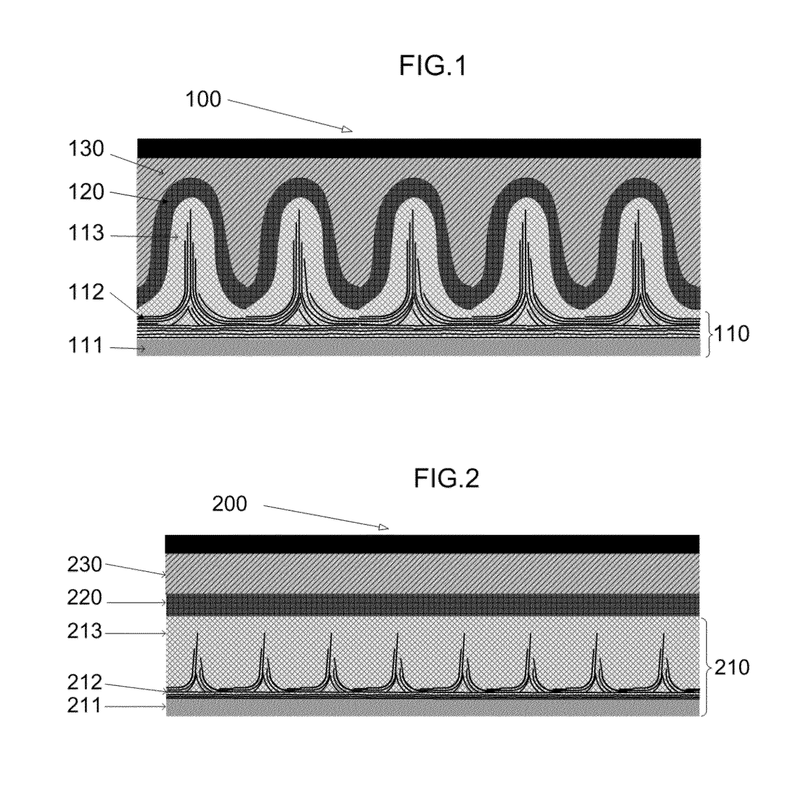

Referring to FIG. 1, it shows a schematic diagram of a battery 100 with a cathode comprising of a plurality of carbon nanosheets in a cross-sectional view, in accordance with the first exemplary embodiment. In the first exemplary embodiment, a thin-film cathode active material is conformally coated on the surface of a plurality of vertically free-standing carbon nanosheets, and a thin film electrolyte is conformally coated on top of the cathode active material. Furthermore, active material of an anode fully impregnates the porous space between the plurality of coated carbon nanosheets, and forms a planar topography on its top surface interfacing with a current collector of the anode.

As shown in FIG. 1, the battery 100 includes a cathode 110, a thin film electrolyte 120 and an anode 130. The thin film electrolyte 120 in 3D nanostructure is sandwiched between the cathode 110 and the anode 130. The electrolyte 120 could be in a gel, polymer or solid state. The cathode 110 of the battery 100 comprises a current collector 111, a plurality of vertically free-standing carbon nanosheets 112, and a cathode active material (usually a metallic-oxide) 113. The current collector 111 with a planar shape is used as an electrical contact to make a connection with an external electrical circuit. The plurality of carbon nanosheets 112 stand vertically on the current collector 111. The cathode active material 113 is conformally coated on top of the current collector 111 and the plurality of carbon nanosheets 112, and the electrolyte 120 is conformally coated on top of the cathode active material 113 as well. As a result, a 3D structure is formed in accordance with the topography of the carbon nanosheets 112 and the current collector 111. The thin film electrolyte 120 is capped by the anode 130 with a planar structure. The cathode 110, the electrolyte 120 and the anode 130 are in contact with each other sequentially to form the battery 100.

The current collector 111 is made of an electrical conductive material such as copper. The current collector 111 of the anode 130 can be made by other similar materials as well. It is known that other metals, such as gold, silver, nickel, stainless steel, and various electrical conductive metals or alloys, may be used for a current collector. Additionally, a basic collector of metal foil, e.g. stainless steel SS304, can be plated with another metal such as gold in order to reduce manufacture cost, improve the electrical properties of the junction, and to provide a better substrate for carbon nanosheet attachment. Likewise, polymers foil with a metallic coating can be used as the current collector 111. Alternatively, the current collector of a cathode and/or the current collector of an anode can be a doped semiconductor, polysilicon or their equivalents, or a metal layer on a semiconductor substrate. For example, a collector can be formed as a high melting point metallic coating layer on a silicon substrate. Moreover, a current collector can be formed into various shapes such as rectangles, circles, or any other shape. Further, a current collector can have different surface textures. For example, surface of a current collector can be roughened, trenched, etched, foamed or “corrugated” in order to enlarge the active surface area of the electrodes. The current collector of an anode can be surface engineered in similar ways as the current collector of a cathode.

The cathode active material 113 can be a metallic oxide such as MnO₂ for a Zinc-ion battery, or LiCoO₂ for a Li-ion battery, in a crystallized or amorphous structure with various crystal grain sizes. It is known in the art that other materials (e.g., LiFePO₄) can also be used as cathode active materials. Cathode active materials can be placed by various methods like vapor deposition, sputtering deposition, electroplating, electrodeposition, printing and paste coating, or other methods known in the art.

A cathode active material is typically pseudomorphically mimicking the topography of carbon nanosheets. However, any other topography can be shaped. Cathode active materials can have various spatial structures and surface textures. For example, the layer of cathode active material 113 has a 3D spatial nanostructure, such as coalesced islands at nanoscale (e.g., “nanobeads” or “nano-hemispheres”), which is determined by various processes of modulating thin film coating.

An anode is normally composed of metal, silicon, or metal oxide. It is known that anode and cathode can be straight, stiff and self-supported, or be flexible, rolled and placed into a canister, or be in cylindrical form. The battery 100 can be encapsulated in a plastic pouch as well.

An electrolyte allows free diffusion of charge-carrier ions but prevents transporting of electrons, and hence an electrolyte always comprises non-electron-conductive materials in order to prevent a short in internal circuit. An electrolyte could be in one of various forms, for example, I) a liquid electrolyte for “wet” batteries which have a separator being made of a porous membrane, II) a gel/polymer/paste electrolyte for dry batteries, and III) a glass-type electrolyte for solid-state thin film batteries.

Although an electrolyte is typically pseudomorphically mimicking topography of a cathode, however, any other topography can also be shaped. Likewise, the electrolyte layer 120 can have various spatial structures and surface textures, for example, it can be roughened, and it can include porous openings. In the first embodiment, the electrolyte layer 120 has a 3D spatial nanostructure determined by the molding effect of the vertically free-standing carbon nanostructures. Additionally, the electrolyte 120 can be made by one of various materials, such as alkali (e.g. KOH), acid (e.g. H₂SO₄), or non-aqueous polymer (e.g. poly(ethylene oxide)), or a glass material (e.g. LiPON).

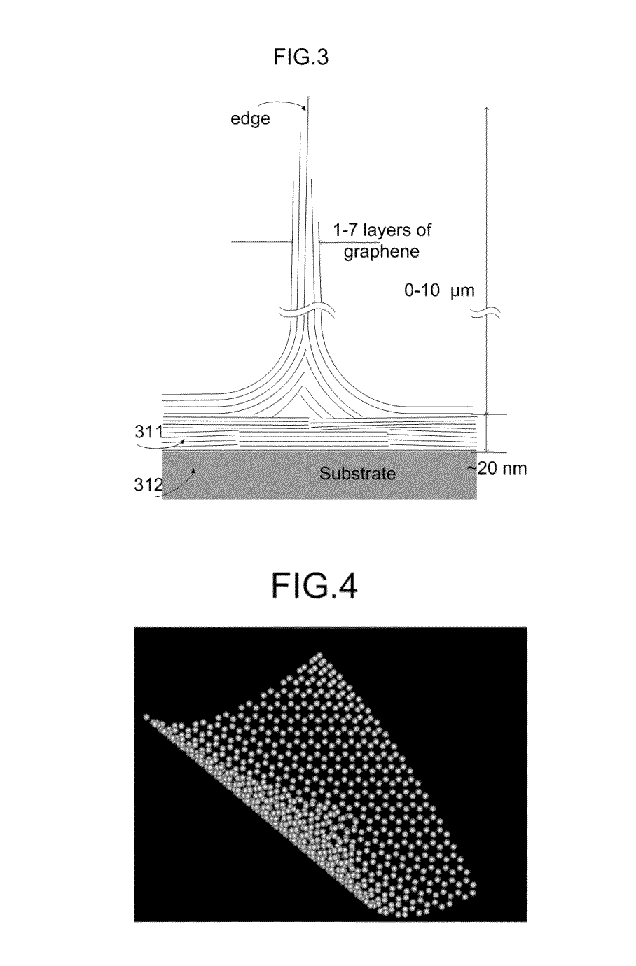

Referring to FIG. 3, it shows a detailed view of a carbon nanosheet in accordance with an exemplary embodiment. A current collector 312 is covered by a plurality of carbon nanosheets 311. The plurality of carbon nanosheets 311 can be disposed to or grow in-situ on the current collector 312 through various methods known in the art such as a thermal chemical vapor deposition method or a Microwave/RF plasma-enhanced chemical vapor deposition method. Surface of the carbon nanosheets 311 can be activated by various methods. Likewise, the density (e.g. spatial density and width/height) of the carbon nanosheets 311 and the attachment geometry between the carbon nanosheets 311 and the current collector 312 may vary. The carbon nanosheets 311 can grow orthogonally on the current collector 312 (e.g. vertically free-standing from the surface of the current collector 312). By varying the spatial density of the carbon nanosheets 311, the active surface area of the current collector 312 can be modulated. Furthermore, the spatial density of carbon nanosheets can affect the efficiency of an electrolyte. The carbon nanosheets 311 can also be of various sizes, thicknesses, and shapes (width and height). For instance, the carbon nanosheets 311 can have a single layer or multiple layers of graphene.

Essentially, in the first exemplary embodiment, the vertically free-standing carbon nanosheets improve battery performance in at least two aspects. First, because the carbon nanosheets grow vertically on the current collector, this “space-organizer” morphology can enhance the specific area of the current collector and increase the electrical conductivity between the far-reaching cathode active material and the current-collector, thus reducing the internal resistance of the battery. Further, the high strength and flexibility of the carbon nanosheets are also favorable for the roll-to-roll manufacturing of thin film batteries. Second, the 3D structure inside the battery is formed by organizing space via the plurality of carbon nanosheets at nanometer scales, the electrolyte and the active material of the electrodes have super large contacting area, and hence conductivity of the battery is enhanced.

With respect to FIG. 2, it shows a schematic diagram of a battery 200 with a cathode comprising a plurality of carbon nanosheets in a cross-sectional view, in accordance with the second exemplary embodiment. In the second exemplary embodiment, a cathode active material fully impregnates and fills up the nanoporous space between the plurality of vertically free-standing carbon nanosheets, and it forms a planar topography on its top surface to contact with a planar layer of a thin-film electrolyte. Further, a thin film layer of an anode is on top of the thin film electrolyte.

As shown in FIG. 2, the battery 200 comprises a cathode 210, an electrolyte 220 and an anode 230. The electrolyte 220 with a planar structure is sandwiched between the cathode 210 and the anode 230. The cathode 210 of the battery 200 comprises a current collector 211, a plurality of vertically free-standing carbon nanosheets 212, and a cathode active material (usually a metallic-oxide) 213. The current collector 211 with a planar shape is used to connect with an external electrical circuit. The plurality of carbon nanosheets 212 stand vertically on top of the current collector 211, and the cathode active material 213 is coated on top of the current collector 211 and the plurality of carbon nanosheets 212. Thickness of the cathode active material 213 is larger than height of the plurality of vertically free-standing carbon nanosheets. Furthermore, the electrolyte 220 is coated on top of the cathode 210 and follows the contour of the cathode 210, and hence forming a planar structure, and the anode 230 is on top of the electrolyte 220. In this way, the cathode 210, the electrolyte 220, and the anode 230 are in contact with each other sequentially to form the battery 200.

The current collector 211, the electrode active material 213, and the electrolyte 220 in the battery 200 may be made by the same materials as those of their corresponding components in the battery 100. The vertically free-standing carbon nanosheets 212 of the battery 200 may also be the same as those of the battery 100, except that the carbon nanosheets 212 of battery 200 are lower than the cathode active material 213.

In the second exemplary embodiment (see FIG. 2.), the plurality of carbon nanosheets 212 enhance the specific area of the current collector and increase the conductivity of cathode active material/current collector interface, thus reducing the internal resistance of the battery 200. Due to the very high mechanical strength of the carbon nanosheets 212, like a scaffold, the carbon nanosheets 212 can support the cathode active material 213 to grow into a thicker layer, which is favorable for higher energy storage capacity because of a larger active mass load.

Considering that the active material of a cathode is normally a poor electrical conductor such as a metallic oxide, vertically free-standing carbon nanosheets provide additional electrical conductivity in a direction through thickness of the cathode active material, thus enhancing conductivity of the cathode. Such high conductivity or low internal resistance is favorable for high power output of a battery. Furthermore, high strength and flexibility of the carbon nanosheets is also favorable for the roll-to-roll manufacturing of thin film batteries.

Furthermore, a critical distinction between the first exemplary embodiment and the second exemplary embodiment is that the electrolyte 220 in the second exemplary embodiment has a planar structure while the electrolyte 120 in the first exemplary embodiment has a 3D conformal morphology.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A battery, comprising:
a cathode, comprising a plurality of carbon nanosheets and a cathode active material;
an anode; and
an electrolyte located between the cathode and the anode,
wherein the cathode and the anode are impregnated with the electrolyte; and
wherein the plurality of carbon nanosheets are vertically free-standing with respect to a surface to which they are attached such that the plurality of carbon nanosheets are embedded or immersed into the cathode active material.

2. The battery of claim 1, wherein:
the cathode further comprises a current collector, wherein the plurality of carbon nanosheets at least partially cover a surface of the current collector.

3. The battery of claim 2, wherein:
the cathode active material is conformally coated on top of the current collector and the plurality of carbon nanosheets, and the electrolyte is conformally coated on top of the cathode active material.

4. The battery of claim 3, wherein:
the anode comprises an anode active material and a current collector, and the anode active material fully impregnates the porous space between the plurality of carbon nanosheets, forming a planar topography on its top surface interfacing with the current collector of the anode.

5. The battery of claim 4, wherein:
the electrolyte has a 3D conformal morphology.

6. The battery of claim 2, wherein:
the cathode active material fully impregnates and fills up nanoporous space between the plurality of carbon nanosheets and on top of the current collector, forming a planar topography on its top surface to contact with the electrolyte.

7. The battery of claim 6, wherein:
the electrolyte is coated on top of the cathode and follows the contour of the cathode to form a planar structure.

8. The battery of claim 7, wherein:
the electrolyte has a planar structure.

9. The battery of claim 1, wherein:
the cathode active material is attached on the current collector with the plurality of carbon nanosheets by sputtering deposition, vapor deposition, printing, spraying, electroplating, electrodeposition or pasting.

10. The battery of claim 1, wherein:
the electrolyte, with or without a separator, is in a form of liquid, paste, polymer, gel, or solid.

11. The battery of claim 1, wherein the plurality of carbon nanosheets are disposed via their edges on the current collector of the cathode.

12. The battery of claim 1, wherein the plurality of carbon nanosheets are in a substantially pure form.

13. The battery of claim 1, wherein each of the plurality of carbon nanosheets has a thickness of 2 nanometers or less.

14. The battery of claim 1, wherein:
each of the plurality of carbon nanosheets has a thickness of 1 nanometer or less.

15. The battery of claim 1, wherein
each of the plurality of carbon nanosheets comprises one to seven layers of graphene.

16. The battery of claim 1, wherein
each of the plurality of carbon nanosheets comprises one layer of graphene.

17. The battery of claim 1, wherein:
each of the plurality of carbon nanosheets has a specific surface area between 1000 m²/g and 2600 m²/g; and
each of the plurality of carbon nanosheets has a height between 100 nm and 8 μm.

18. A method for making a battery, comprising:
forming a cathode including a plurality of carbon nanosheets and a cathode active material, wherein each of the plurality of carbon nanosheets is vertically free-standing with respect to the cathode active material such that the plurality of carbon nanosheets are fully integrated into the cathode active material; and
providing the cathode to a battery.

19. The method of claim 18, wherein the plurality of carbon nanosheets are disposed via their edges on the cathode active material.
